(19) United States
(12) Patent Application Publication
(10) Pub. No.: US 2022/0192154 A1
(43) Pub. Date: Jun. 23, 2022

(54) ANIMAL FITNESS GARMENT

(71) Applicant: MVP K9 Supplements, LLC, Forney, TX (US)

(72) Inventor: STANLEY LAWRENCE SMITH, Forney, TX (US)

(21) Appl. No.: 17/690,199

(22) Filed: Mar. 9, 2022

Related U.S. Application Data
(63) Continuation-in-part of application No. 16/298,602, filed on Mar. 11, 2019.
Application No. 16/298,602 is a continuation-in-part of application No. 29/621,211, filed on Oct. 5, 2017, now Pat. No. D866876.

(51) Int. Cl. A01K 13/00; A01K 15/02

(52) U.S. Cl. CPC A01K 13/006; A01K 15/027

(57) ABSTRACT

An animal fitness garment includes a body panel and a shoulder section that includes a pair of shoulder panels extending therefrom at an angle. The shoulder section is resiliently attached to the body panel through one or more resilient sections. In addition, each shoulder section may be resiliently attached to a base section that connects each of the shoulder panels together. This resilient configuration allows the animal fitness garment to conform to the shape and contour of the shoulders of the animal, so as to increase the comfort of the vest, while reducing the physical stress imparted to the animal when the garment is worn.

### CROSS-REFERENCE TO RELATED APPLICATIONS

This application is a continuation-in-part of U.S. patent application Ser. No. 16/298,602, filed on Mar. 11, 2019, which is a continuation-in-part of U.S. Design patent application Ser. No. 29/621,211 filed on Oct. 5, 2017, all of the contents of which are incorporated herein by reference.

### TECHNICAL FIELD

The various embodiments disclosed herein relate to animal garments. Particularly, the various embodiments disclosed herein relate to garments that are worn by animals to improve their fitness. More particularly, the various embodiments disclosed herein relate to a garment for animals that accommodates adjustable levels of weight, and provides resilient sections to reduce strain to an animal's neck and shoulders, while providing internal perforated pockets to retain heating or cooling packs.

### BACKGROUND

Animals, including pets, such as dogs, have an innate level of physical and emotional companionship with their owner. Pets are viewed by their owners as rewarding, supportive, and therapeutic. In fact, pets are able to improve the emotional and/or physical state of their owners.

While pets serve to improve the quality of life of their owners, they require a certain amount of maintenance to ensure that they remain in optimal health. In fact, pets, such as dogs, require cardiovascular exercise to maintain their physical and mental well-being. However, many pet owners due to their hectic schedules are unable to find sufficient time to take their pets on walks or runs to give them exercise. In fact, most pet owners don't even have enough spare time to simply let their pets out of the house to roam freely on their own. Such inactivity results in a pet that has reduced levels of physical and mental fitness. For example, a dog that is not routinely allowed to run may become disinterested, unhappy, and anxious, thus leading to behavioral and obedience problems. Furthermore, the reduced activity results in atrophy of their musculature, leading to injury, as well as an increase in disease, such as canine diabetes for example. As the many benefits of exercise for pets are apparent, it is critical that they have the exercise they need in order to allow them to live happy and fulfilling lives and to serve as robust companions to their owners.

Therefore, it is desirable to provide a wearable garment for a pet or animal that can improve their physical and/or mental health. In addition, there is a wearable garment for a pet or animal that imparts weight to the animal to improve its strength. Furthermore, there is a need for a wearable garment that includes perforated pockets to retain heating or cooling packs to impart therapeutic treatment to the animal. Still yet, there is a need for a wearable garment that includes a shoulder section for attachment about the neck of the animal, whereby the shoulder section is resiliently attached to a main body panel of the wearable garment to reduce the strain to the animal's neck and shoulders. There is also a need for a wearable garment that includes individual shoulder panels for attachment about the neck of the animal, whereby each shoulder section includes a resilient section to reduce strain to the animal's neck and shoulders.

### SUMMARY

In light of the foregoing, it is an aspect of the various embodiments disclosed herein to provide a garment for an animal comprising a body panel configured to be carried upon at least a portion of the animal, said body panel having an outer surface and an inner surface, said inner surface adapted to be positioned proximate to the animal when the garment is worn; a first pocket and a second pocket carried on said outer surface of said body panel; a first fastener configured to releasably couple one point of said body panel to another point of said body panel, so as to form an opening to receive at least a portion of the animal therethrough; a first shoulder panel; a second shoulder panel joined to said first shoulder panel to form a shoulder section, wherein said shoulder section is resiliently attached to said body panel; and a second fastener configured to releasably couple an end of said first shoulder panel to and end of said second shoulder panel, so as to form an opening to receive a head of the animal therethrough.

It is another aspect of the various embodiments disclosed herein to provide a garment for an animal comprising a body panel configured to be carried upon at least a portion of the animal; a first pocket and a second pocket carried on said body panel; a first fastener configured to releasably couple one point of said body panel to another point of said body panel, so as to form an opening to receive at least a portion of the animal therethrough; a first shoulder panel resiliently attached to said body panel; a second shoulder panel resiliently joined to said body panel; and a second fastener configured to releasably couple an end of said first shoulder panel to and end of said second shoulder panel, so as to form an opening to receive a head of the animal therethrough.

It is yet another aspect of the various embodiments disclosed herein to provide a garment for an animal comprising a body panel configured to be carried upon at least a portion of the animal, said body panel having an outer surface and an inner surface, said inner surface adapted to be positioned proximate to the animal when the garment is worn; a first pocket and a second pocket carried on said outer surface of said body panel; a first fastener configured to releasably couple one point of said body panel to another point of said body panel, so as to form an opening to receive at least a portion of the animal therethrough; a first shoulder panel; a second shoulder panel joined to said first shoulder panel by a base section to form a shoulder section, wherein said first and second shoulder panels are resiliently attached to said base section; and a second fastener configured to releasably couple an end of said first shoulder panel to and end of said second shoulder panel, so as to form an opening to receive a head of the animal therethrough.

### BRIEF DESCRIPTION OF DRAWINGS

These and other features and advantages of the various embodiments disclosed herein will become better understood with regard to the following description, appended claims, and accompanying drawings, wherein:

FIG. 1 is an elevational view of an animal fitness garment worn by a dog in accordance with the various embodiments disclosed herein;

FIG. 2 is a plan view of an outer surface of the animal fitness garment in accordance with the various embodiments disclosed herein;

FIG. 3 is a plan view of an inner surface of the animal fitness garment in accordance with the various embodiments disclosed herein;

FIG. 4 is a partial plan view of the various pockets provided by the animal fitness garment in accordance with the various embodiments disclosed herein;

FIG. 5A is a perspective view of a packet that is in a closed state, which is configured for insertion into the pocket provided by the animal fitness garment in accordance with the various embodiments disclosed herein;

FIG. 5B is a perspective view of the packet that is in an opened state, which is configured for insertion into the pocket provided the animal fitness garment in accordance with the various embodiments disclosed herein;

FIG. 6 is a perspective view of the animal fitness garment in accordance with the various embodiments disclosed herein;

FIG. 6A is an elevational view of a cam buckle clip used with the animal fitness garment in accordance with the various embodiments disclosed herein;

FIG. 7A is a top plan view of the dog that is not wearing the animal fitness garment in accordance with the various embodiments disclosed herein;

FIG. 7B is a top plan view showing the dog wearing the animal fitness garment in accordance with the various embodiments disclosed herein;

FIG. 8A is a top plan view showing another embodiment of the animal fitness garment in accordance with the various embodiments disclosed herein;

FIG. 8B is a top plan view showing still another embodiment of the animal fitness garment in accordance with the various embodiments disclosed herein; and

FIG. 8C is a bottom plan view showing yet another embodiment of the animal fitness garment having in accordance with the various embodiments disclosed herein.

### DETAILED DESCRIPTION

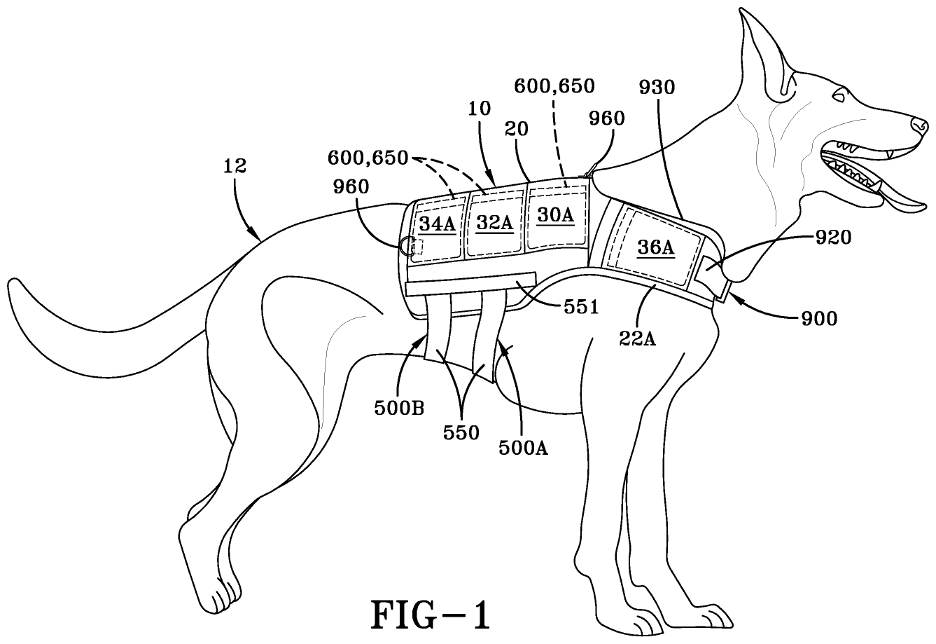

An animal fitness garment is generally referred to by reference numeral 10, as shown in FIG. 1. The animal fitness garment 10 is configured to be worn by an animal 12, such as a dog, to improve its fitness in a manner to be discussed. The body panel 20 may include pockets 30, 32, and 34, while the shoulder panels 22A-B may include pockets 36. The external pockets 30-36 are configured to removably retain weighted material therein to increase the weight that is carried by the animal 12. This serves to increase the physical exertion of the animal 12 as it walks and runs, or otherwise exercises, so as to increase the level of physical performance and stamina of the animal 12. In other words, the pockets 30-36 allow an individual to customize the amount of weight that is inserted therein to set the level of total weight the animal 12 carries. In addition, the body panel 20 may include internal pockets 37A-B that are configured to receive heating and/or cooling packets to deliver therapeutic levels of heating and cooling to the animal's body. The body panel 20 and the shoulder panels 22A-B of the garment 10 are secured to the animal 12 via various respective fasteners to be discussed. Accordingly, when the animal fitness garment 10 is secured to the animal 12, the garment 10 is capable of accommodating the vigorous and energetic movement of the animal 12 and remains secured to the animal 12 without allowing the weighted pockets 30-36 and garment 10 to move out of their intended optimal position. It should be appreciated that while the garment 10 is discussed herein as being used for a dog, such should not be construed as limiting, as the garment 10 may be sized as necessary to be worn by any 4-legged animal, including but not limited to dogs, cats, horses and the like.

In some embodiments, the panels 20 and 22A-22B may be formed from any suitable material, including but not limited to fabric, such as woven fabric, plastic, carbon fiber, metal, or any combination thereof. It should be appreciated that in some embodiments, the material forming one or more of the panels 20 and 22A-22B may comprise NYLON material, such as ballistic NYLON. In some embodiments, the materials used to form one or more of the panels 20 and 22A-B may be waterproof. In addition, the material used to form one or more of the panels 20 and 22A-B may be configured as one layer of material, or may be formed of multiple stacked, layered, or overlapping layers of material, so as to be laminated or partially laminated together. In the case of the use of a laminated or layered material, a padding material having a suitable resiliency may be situated between one or more pairs of consecutive material layers of the panels 20,22 to impart a padded and comfortable fitment to the animal 12 when the garment 10 is fitted and secured thereto. For example, in some embodiments, the padding may be formed of resilient material, such as foam, including conformable foam or memory foam, fabric fibers, and the like.

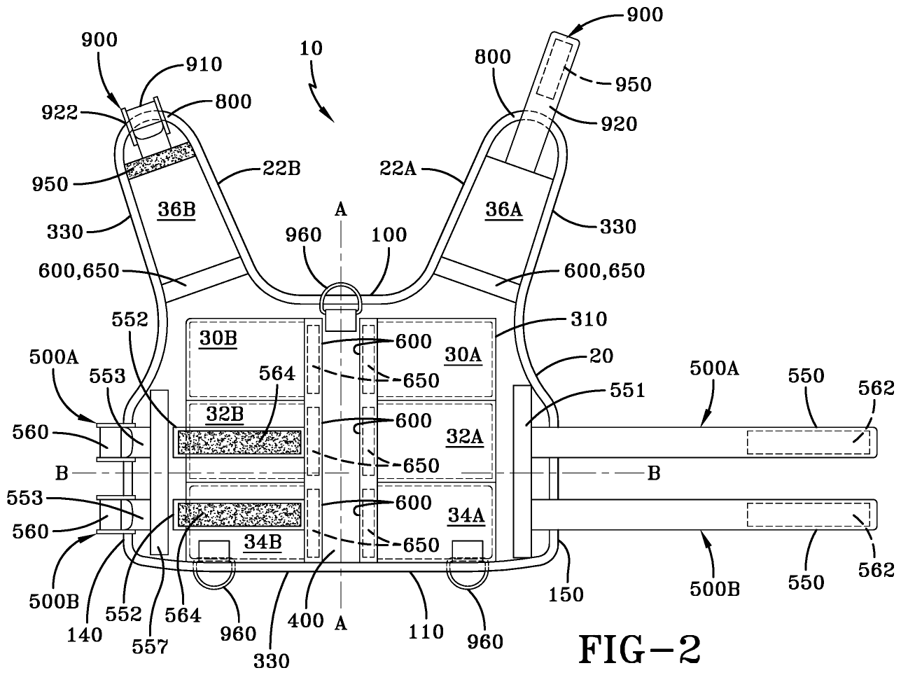

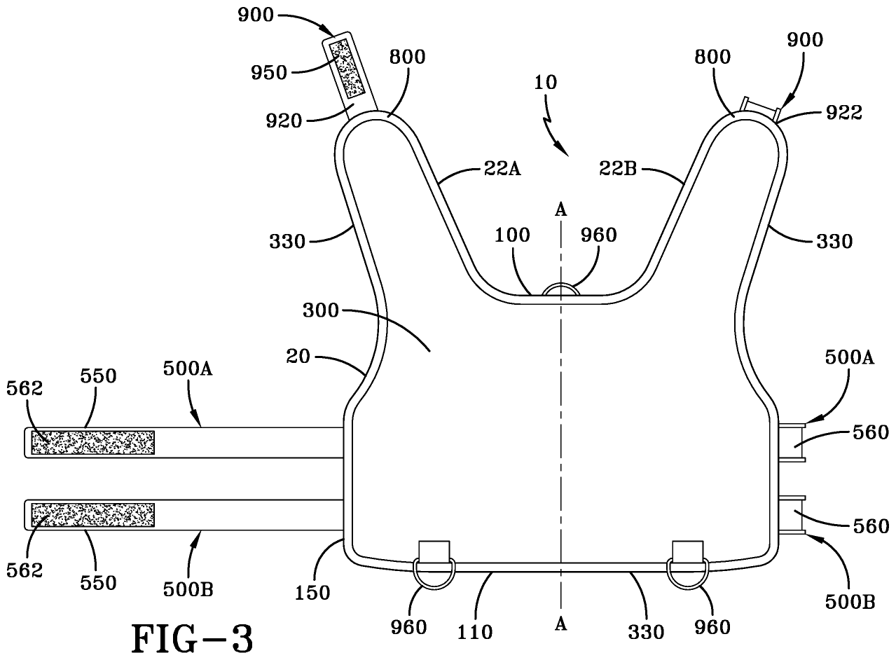

The garment 10, as shown in FIGS. 2 and 3, has a longitudinal axis A that extends through a front end 100 to a rear end 110 of the body panel 20. In addition, the body panel 20 includes a latitudinal axis B, which extends at a substantially right angle to that of the longitudinal axis A, and between the opposed lateral sides 140 and 150 of the body panel 20. The longitudinal axis A is configured to be substantially aligned with a spine 200 of the animal 12 when the garment 10 is worn, as shown in FIGS. 7A-B. The body panel 20 has an inner surface 300 (formed of one or more material layers) and an outer surface 310 (formed of one or more material layers) that are joined or attached at an edge 330 using any suitable technique, including but not limited to sewing, stitching, stapling, riveting, adhesive, or the like. As previously discussed, any suitable material, such as a foam material, may be disposed between the material layers forming the inner and outer surfaces 300,310.

Disposed on the outer surface 310 of the body panel 20 are a plurality of pocket pairs 30A-B, 32A-B, 34A-B such that one pocket of each pair is positioned on one side of a central section 400, and the other pocket of each pair is positioned on the opposite side of the central section 400. The central section 400 of the body panel 20 is parallel and is in substantial alignment with the longitudinal axis A. In particular, the central section 400 extends substantially linearly from the front 100 of the body panel 20 proximate to an area of the edge 330 that is positioned midway between the shoulder panels 22A and 22B to an area of the edge 330 that is positioned at the rear 110 of the body panel 20. It should be appreciated that the width of the central section 400 may be of any suitable dimension, and it is this width that separates each pocket of a given pair 30A-B, 32A-B, and 34A-B. It should be appreciated that in some embodiments, the central section 400 may include webbing material, such as molle webbing for example. It should be appreciated that in some embodiments the central section 400 may include more material layers and may be made more or less rigid than other portions or panels 20,22 of the garment 10 but is not necessary. In some embodiments, the central section 400 is made rigid, such as through one or more layers of material, a rigid insert, such as plastic or metal, so that the section 400 resists bending and flexing, but is not necessary.

The body panel 20 also includes fasteners 500A-B, which in some embodiments may include snaps, buttons, zippers, and clips, as well as any other suitable means for selectively/releasably securing the lateral sides 140 and 150 of the body panel 20 together in order to secure the body panel 20 around circumference of the body of the dog 12. In some embodiments, as shown in FIG. 2, the fasteners 500A-B include a plurality of spaced straps 550 attached to one side 150 of the body panel 20, and a plurality of retaining clips 560 that are attached to another side 140 of the body panel 20 to selectively retain the straps 550 thereto. It should be appreciated that the straps 550 are attached at a position proximate to the edge of side 150 of the body panel 20. In addition, a longitudinally positioned member 551 may be provided to reinforce the point of attachment of the straps 550 to the body panel 20. Straps 553, and members 551,557 may be formed of the same material as the garment 10. In addition, the retaining clips 560 may be attached by straps or loops 553 that are attached at a point proximate to an edge that is proximate to side 140 of the body panel 20. In addition, straps 552 are also provided so that they extend from a point proximate to the central section 400 to a point proximate to the edge of side 140 of the body panel 20. In addition, a longitudinally positioned member 557 may be provided to reinforce the point of attachment of the straps 553 to the body panel 120. The straps 550, 552 and 553 may be attached to the outer surface of the body panel 20 using any suitable technique, including sewing stiches, staples, rivets, adhesive or the like, or combinations thereof.

The straps 550 may comprise any suitable material, such as NYLON, and may include hook/loop material 562, such as VELCRO, which is configured to be attached to counterpart hook/loop material 564 that is positioned proximate to the retaining clip 560 and on the strap 552 to further secure the body panel 20 to the animal 12. It should also be appreciated that in some embodiments, the retaining clips 560 are not utilized, and only the hook/loop material is used to removably secure the straps 550 around the dog 12 and to the straps 552. It should be appreciated that while two fasteners 500A and 500B are shown, one or more fasteners may be used in other embodiments.

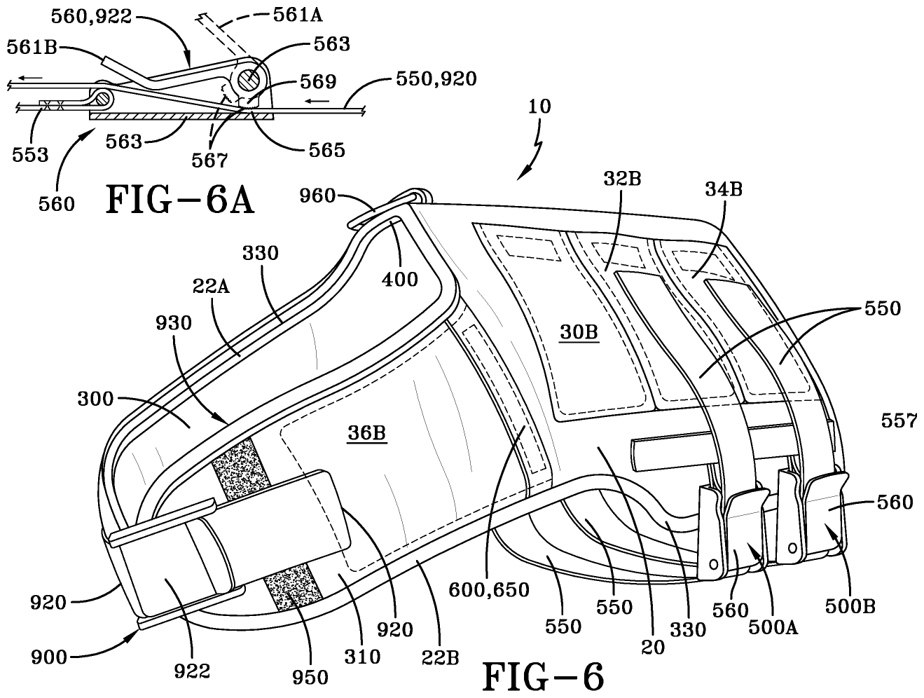

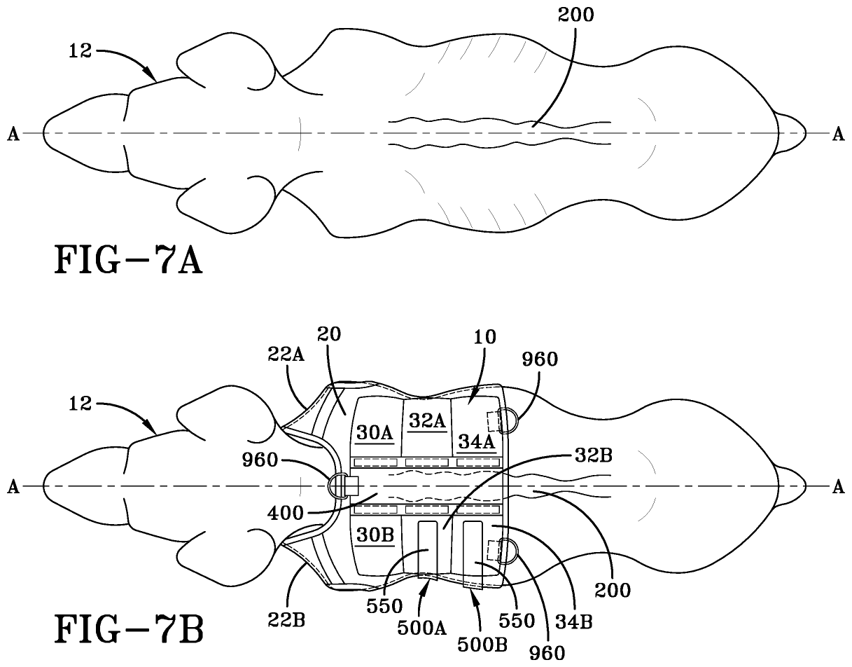

In some embodiments that retaining clips 560 may comprise cam buckle clips to secure the straps 550. The straps 550 include hook/loop material, such as VELCRO on the ends, which attach to hook/loop or VELCRO 564 once the straps 550 are fed through the cam buckles 560. The cam buckle clip 560 provides additional security and prevents the straps 550 from becoming tighter or loosened as the animal 12 performs activities. The width size of the strap 550 is determined by the clip width size, and in some cases the size of the animal 12. The cam buckle clip 560, as shown in FIG. 6A, may include a pivoting lever 561 that pivots on an axis 563, and that has a cam-shaped lobe 569. The lever 561 may be spring-biased. In addition, a member 565 is spaced apart by a gap from the lobe 569, so that the strap 550 may be received therethrough. Accordingly, when the strap 550 is pulled through the gap, the lever 561 may be moved from an unlocked state 561A to a locked state 561B so that the teeth 567 carried by the cam lobe 569 bite into the strap 550 and compress the strap 550 against the member 562 to prevent the strap 550 from moving. Alternatively, when the lever 561 is moved in an opposite direction from the locked state 561 B to the unlocked state 561A, the strap 550 is released from the clip 560, so that the strap 550 can move freely through the gap. The cam buckle clip 560 prevents the unwanted tightening and/or loosening of the tension on the straps 550 that was applied by the user when the garment 10 was originally attached to the dog 12, which may otherwise have occurred during training movements by the dog 12. This ensures that the garment 10 always remains properly fitted to the dog 12 as the owner intended during training movements by the dog 12. It also ensures that the safety and well-being of the dog 12 is maintained, preventing harm and injury to the dog 12.

It should be appreciated that the positioning and attachment of the straps 550 and 552 to the body panel 20 increases the amount of retention force that is applied across the body panel 20 and delivered about the torso of the animal 12 when the clips 560 are secured to the ends of the straps 550. As a result of this retention force, the garment 10 substantially resists movement on the dog 12 when it is vigorously moving during training, such as running or jumping for example; and ensures that the weight contained in the pockets 30-34 is in a consistently stable and proper position, so as to prevent injury to the animal 12.

In other embodiments, the retaining clips 560 may comprise single-adjust side release buckle clips that are attached to the straps 550 without the use of VELCRO.

The pairs of pockets 30A-B, 32A-B, and 34A-B are arranged, such that one pocket of each set, such as pockets 30A, 32A, and 34A, are positioned on one side of the central section 400 (or longitudinal axis A), while the other counterpart pockets of the set, such as pockets 30B, 32B, and 34B, are arranged on the opposite side of the central section 400 (or longitudinal axis A) of the body panel 20. In addition, each of the pockets 30A-B, 32A-B and 34A-B include an opening 600. Thus, for a given pair of pockets 30A-B, 32A-B and 34A-B, each of their openings 600 are spaced apart from each other by the width of the central section 400 between them. In addition, one or more of a given pair of pockets 30A-B, 32A-B and 34A-B may be arranged so that their openings 600 are axially aligned with each other. For example, the openings 600 of pockets 30A-B may be axially aligned, as well as the openings of pockets 32A-B, and 34A-B for example. In particular, each of the pockets for a given pair 30A-B, 32A-B and 34A-B may be arranged so that their respective longitudinal axes, which extend parallel to latitudinal axis B of the body panel 20, are aligned. Such longitudinal alignment of each set of pockets 30A-B, 32A-B, and 34A-B on either side of the central section 400, or longitudinal axis A, ensures that the weight that is added into the one or more pockets 30, 32, 34 by the user is equally and uniformly arranged and distributed on the animal 12. In other words, this ensures that the weight is uniformly distributed upon the back of the animal 12 and not placed directly over the animal's spine 200. It should also be appreciated that while three pairs of pockets are shown, the garment 10 may be configured to include one or more pairs of pockets as desired. In addition, the pockets may be of any desired size. In the case of the use of multiple pairs of pockets, the pockets 30A-B, 32A-B, 34A-B of one pair may be directly adjacent to the pockets of another pair without any space, as shown in the Figs. Alternatively, each adjacent pair of pockets may be spaced apart from another set of pockets by a gap.

The pockets 30A-B, 32A-B and 34A-B may include a closure or fastener 650 to close their openings 600. This closure 650 may include, but is not limited to hook and loop material, such as VELCRO, as well as buttons, snaps, and zippers.

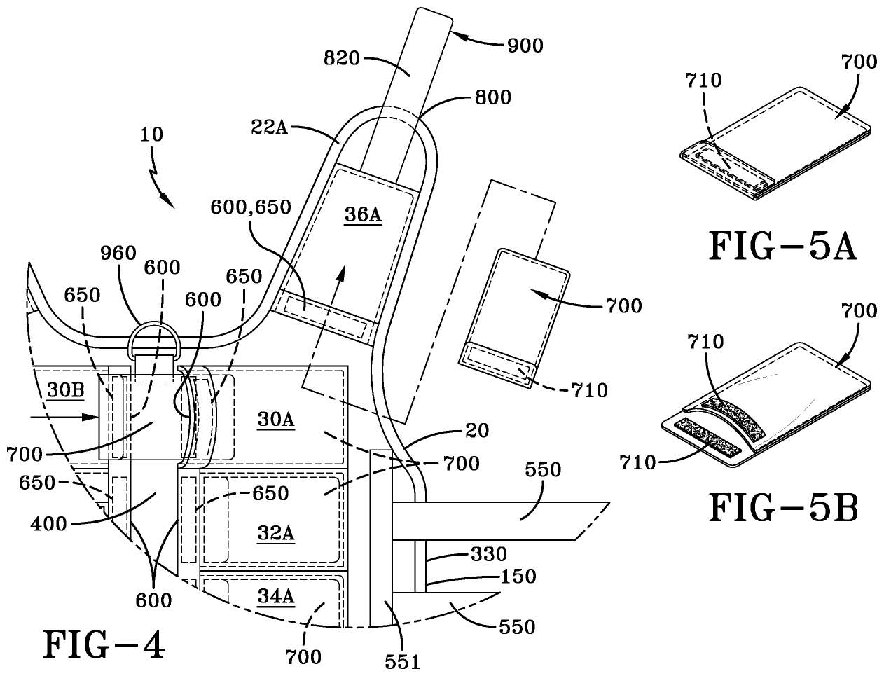

The weight material to be inserted into the pockets 30A-B, 32A-B, and 34A-B may comprise any desired material, including but not limited to sand or similar material; metal or plastic pellets, such as BB's; as well as any other item and the like. The weight material may be placed into a packet or pouch 700, as shown in FIGS. 4 and 5A-B, which may be formed of plastic or fabric before it is placed into the pockets 30A-B, 32A-B, and 34A-B. Furthermore, the bags, packets or pouches 700 may be permanently or selectively sealed (i.e. resealable) using any suitable fastener 710, such as by an interlock closure or hook/loop closure, such as VELCRO for example. In addition, the amount of weight placed in the packets 700 can be modified as necessary, depending on the health and training goals that are being pursued with the animal 12.

Extending from the front edge of the body panel 20 are the shoulder panels 22A and 22B, which are configured to be placed over, or proximate to, the front shoulders of the dog 12 or animal when the garment 10 is placed into use. In some embodiments, the shoulder panels 22A and 22B extend from the front of the body panel 20 at an angle relative to the longitudinal axis A of the body 10. However, it should be appreciated that the shoulder panels 22A-B are configured to fit or lay above the top of the animal's shoulder area around the neck of the animal. In addition, the retaining clip 922 to be discussed may be positioned so that it is centralized near the top of the animal's front chest area, and in some cases proximate to an area below where the bottom of the animal's neck and the top of their chest meet. The shoulder panels 22A-B are elongated and may be any suitable shape. The shoulder panels 22A-B may also be formed in the same manner as previously discussed with regard to the body panel 20. In addition, the shoulder panels 22A-B each have the inner surface 300 and the outer surface 310 that is co-extensive with the body panel 20. Disposed on the outer surface 310 of respective shoulder panels 22A and 22B are pockets 36A and 36B. The pockets 36A-B each have the opening 600. In some embodiments, the opening 600 faces toward the rear end 110, and is positioned such that the end of the pocket 36A-B is proximate to the longitudinal axis A of the garment 10. In addition, each of the pockets 36A-B includes the closure 650 that may be selectively closed as previously discussed. Additionally, the pockets 36A-B are configured to receive the packets or pouches 700 of weight material previously discussed.

Each of the shoulder panels 22A-B extends from the body panel 20 to a terminal end 800 where they are selectively and releasably joined or attached together by a fastener 900. The fastener 900 may include snaps, buttons, and zippers, as well as any other means for selectively and releasably securing the shoulder panels 22A-B together.

In some embodiments, as shown in FIG. 2, the fastener 900 includes a strap 920 attached to one shoulder panel 22A, and the retaining clip 922 is attached to the other shoulder panel 22B to retain the strap 920 received thereby. In further embodiments, the strap 920 may include hook/loop material 950, such as VELCRO, which is configured to be attached to counterpart hook/loop material 950 or VELCRO that is positioned proximate to the retaining clip 910. It should also be appreciated that in some embodiments, the retaining clip 910 is not utilized, and only the hook/loop material 950 is used to removably secure the strap 920 around the neck of the dog 12. It should be appreciated that the strap 920 and retaining clip 922 are structurally configured in a manner similar to strap 550 and clip 560 respectively, as previously discussed. Thus, the clip 922 may incorporate the cam design of clip 560, as previously discussed.

Thus, when the terminal ends 800 of the shoulder panels 36A-B are attached, an opening 930 is formed for the neck of the dog 12 to extend therethrough, as shown in FIG. 1.

In addition, various accessory loops 960 are attached to the outer surface 310 of the garment 10. In some embodiments, the loops 960 may be formed of fabric or metal loops, such as metal D-rings for example. In particular, one or more loops 962 are positioned at the front end 100 of the garment 10 between the shoulder panels 36A and 36B. In some embodiments, the loops 962 may be positioned on the longitudinal axis A. Furthermore, a pair of loops 962 may be positioned at the rear end 110 of the garment 10 on either side of the central section 400. The loops 960 may be used to attach various accessory equipment to the fitness garment 10. Such accessories may include, but are not limited to a resistance parachute, a weighted drag bag, resistance band, a collapsible water or food bowl, a water bottle having an attachment clip, other items having attachment clips, such as a leash, or the like.

Thus, when the animal fitness garment 10 is placed into use, the inner surface 300 of the body and shoulder panels 20,22 are placed directly adjacent to the body of the animal, such as the dog 12, as shown in FIG. 1. In addition, the central section 400 of the body panel 20 is placed in parallel alignment with, and sits over top of, the spine 200 of the dog 12, as shown in FIG. 7B. Next, the fasteners 500A and 500B are secured around the under-body/torso/waist of the dog 12 to retain the body panel 20 to the dog 12. It should be appreciated that in some cases, the straps 550 may be positioned between an area of the dog's rib cage behind its front legs to an end of the rib cage that is proximate to the dog's abdomen. Alternatively, the straps 550 may be positioned toward the bottom of the dog's rib cage near its abdomen or on the abdomen. However, such positioning should not be construed as limiting, as the garment 10 may be attached in other positions to the dog or other animal 12. In addition, the shoulder panels 22A-B are brought around the neck of the dog 12 to form the opening 930 and fastened together via fastener 900, so that the shoulder panels 22A-B are placed over the shoulders of the animal 12. In addition, the pockets 30A-B, 32A-B, 34A-B and 36A-B may be each individually configured with different or similar amounts of weight as desired. It should also be appreciated that the pocket 36A-B may be oriented on the panel 22 so that they are positioned at least partially over the shoulders of the animal 12 when the garment 10 is fitted to the animal 12.

It should be appreciated that the animal fitness garment 10 is configured so that it fits securely and comfortably on the animal 12, allowing it to remain isolated and in optimal position even during high performance movement activities, including but not limited to running, jumping or training. The retaining clips 560,922 are configured to be adjusted in precise, small increments, such as by the millimeter. The amount of weight provided in the pockets 30, 32, 34 and 36 can be adjusted in very small increments. These precise adjustment features allow pet owners, including dog owners, to make proper adjustments depending on the physical goal they are trying to obtain for their dog.

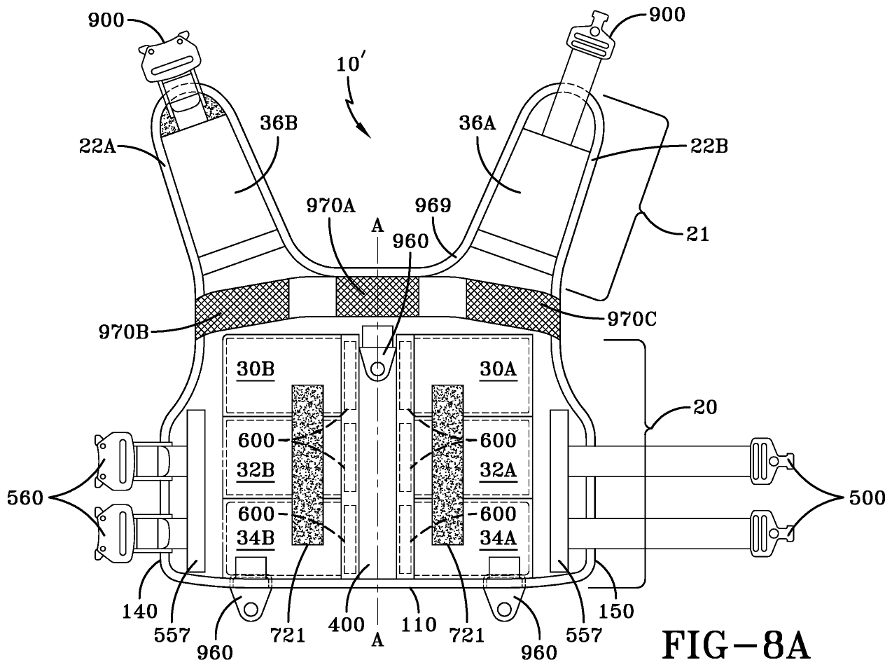

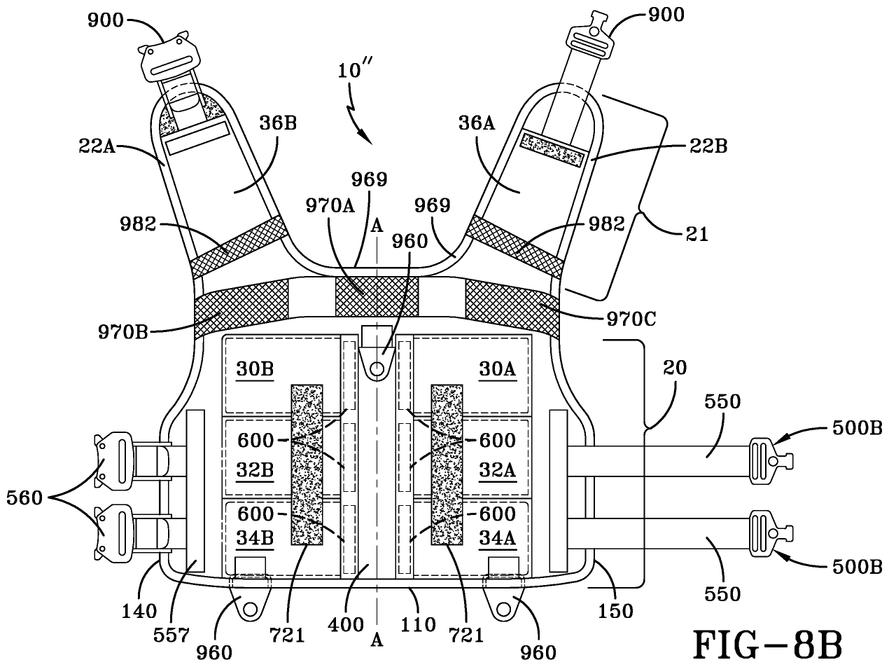

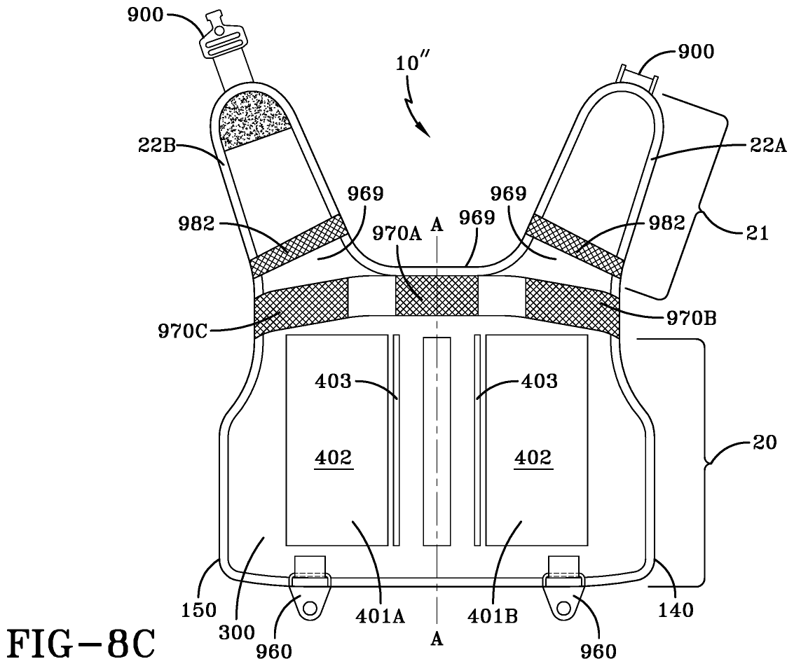

An alternative embodiment of the fitness garment is referred to by reference numeral 10′, as shown in FIG. 8A. The garment 10′ may be configured, such that the body panel 20 is resiliently attached to a shoulder section 21, which includes two shoulder panels 22A and 22B that are joined together by a base section 969. In other words, the shoulder section 21 integrates the shoulder panels 22A and 22B together through the base section 969. This allows the shoulder panels 22A-B to more effectively contour to the profile of the shoulders of the animal.

Continuing, the body section 20 is attached to the shoulder section 21 by one or more resilient sections 970. The resilient sections 970 may be attached to the body panel 20 and the shoulder section 21 using any suitable technique, including but not limited to sewing, stitching, stapling, riveting, adhesive, or the like, including zippers and snaps. It should be appreciated that in some embodiments, the resilient sections 970 may be removably attached to the body panel 20 and the shoulder section 21, such as through zippers, button, snaps, clips and the like. The resilient sections 970 may be formed of any suitable resilient material, such as elastic fabric, resilient polymeric material, including rubber or silicone, as well as combinations thereof. In some embodiments, the resilient sections 970 may be spaced apart from each other by gaps. For example, as shown in FIG. 8A, the resilient sections 970 may be spaced apart, such that one resilient section 970A connects the mid-line A of the shoulder section 21 to the mid-line A of the body panel 20; another resilient section 970B connects the shoulder section 21 at a point proximate the shoulder panel 22A to the body panel 20; while another resilient section 970C connects the shoulder section 21 at a point proximate to the shoulder panel 22B to the body panel 20. It should be appreciated that different widths and lengths of resilient sections 970 may be used to provide a customized fit to the animal. In further embodiments, it should be appreciated that the resilient sections 970A-C may have the same or different amounts of elasticity strength. That is, some resilient sections 970 may be stiffer and more resistant to stretching than other resilient sections 970. For example, resilient section 970A may have a different elasticity strength than that of resilient sections 970B and 970C. It should also be appreciated that one or more resilient sections 970 may be adjustably attached to either of the shoulder section 21 or the body panel 20. For example, one or more ends of the resilient section 970 may be attached to an adjustable fastener, such as an adjustable clip, where the length of the resilient section may be adjustably lengthened or shortened.

It should also be appreciated that the resilient section 970 may comprise a single section that extends across the space between the lateral sides 140 and 150 of the body panel 20. However, in further embodiments, the resilient section 970 may comprise a single section that is positioned anywhere between the lateral sides 140 and 150 of the garment 10′.

It should be appreciated that in other embodiments, the fitness garment 10′ may be configured to include shoulder panels 22A and 22B only, without the use of the base section 969. In other words, the shoulder panels 22A-B are separately and independently attached to the body panel 20 by respective independent resilient sections 970 without the shoulder panels 22A-B being connected by the base section 969 of the shoulder section 21.

In yet another embodiment of the animal fitness garment referred to by reference numeral 10″, and as shown in FIG. 8B, the shoulder panels 22A-B each include a resilient section 982 interposed therein. That is, the resilient sections 982 are positioned at some point along the length of the shoulder panels 22A and 22B. As such, the portion of each of the shoulder panels 22A-B proximate to the fasteners 900 are joined through the resilient section 982 to the base section 969. Furthermore, the resilient sections 982 positioned in the shoulder panels 22A-B as shown in FIG. 8B may also be combined with the resilient sections 970, which connect the body panel 20 to the shoulder section 21. It should be appreciated that the resilient sections 982 may comprise any suitable resilient material, such as elastic fabric, resilient polymeric material, including rubber or silicone, as well as combinations thereof. In some embodiments, the resilient sections 982 may include multiple spaced apart sections that are separated by gaps.

Continuing to FIG. 8C, the animal fitness garment 10″ (as well as the other embodiments 10 and 10′) may be configured, such that disposed on the inner surface 300 of the body panel 20 on each side of the axis A are pockets 401A and 410B. The pockets 401A-B may be made of a fabric panel 402 that is configured to come into direct contact with the animal 12 when the garment 10 is worn. In some embodiments, the fabric panel 402 may be perforated or solid. The pockets 401A-B may be selectively opened and closed, using any suitable closure or fastener 403, such as through zippers, buttons, snaps, clips and the like. The pockets 401A and 401B are configured to retain therein heating and/or cooling inserts or packets, as desired, to deliver therapeutic heating and/or cooling to the body of the animal wearing the garment 10. Accordingly, when the heating and/or cooling packets are in the pockets 401A-B, and the garment 10 is worn by the animal, the pockets 401A-B allow the heating and/or cooling to be therapeutically delivered to the animal. In some embodiments, the pockets 410A-B may be formed of perforated material. It should be appreciated that the pockets 401A-B may comprise a plurality of pockets, which may be positioned adjacent to each other or may be spaced apart from each other.

In other embodiments, attachment sections 721 may be provided on the outer surface 300 of the fitness garment 10, 10′, 10″. In addition, the attachment sections 721 may be configured as snaps, clips or any other suitable fastener, such as hook and loop type material, including VELCRO. The attachment sections 721 may be configured to receive indicia (not shown), such as a patch or a badge, which has suitable hook and loop material to allow for the removable attachment of the indicia to the to the attachment sections 721.

It should also be appreciated that the fasteners/clips 500A-B and the retaining fastener 560, which serves to retain the straps 550 around the animal 12 may be configured to comprise a COBRA brand/type buckle assembly, whereby a clip 500A-B is releasably attached into a fastener 560. However, any suitable two-sided or two-lock locking buckle or fastener assembly, which uses 2 separate/independent locking mechanisms (which may be located on opposite sides of the retaining fastener 560) may be used to embody the clip/fastener 560 and the fastener 500A-B. As such, to release the fastener/clip 500A-B from a counterpart retaining fastener 560, each of the 2 locking mechanisms of the 2-sided locking mechanism used by the retaining fastener 560 must be released so that the fastener/clip 500A-B can be removed from the retaining clip 560.

Therefore, it can be seen that the objects of the various embodiments disclosed herein have been satisfied by the structure and its method for use presented above. While in accordance with the Patent Statutes, only the best mode and preferred embodiments have been presented and described in detail, with it being understood that the embodiments disclosed herein are not limited thereto or thereby. Accordingly, for an appreciation of the true scope and breadth of the embodiments, reference should be made to the following claims.

What is claimed is:

1. A garment for an animal comprising:
a body panel configured to be carried upon at least a portion of the animal, said body panel having an outer surface and an inner surface, said inner surface adapted to be positioned proximate to the animal when the garment is worn;
a first pocket and a second pocket carried on said outer surface of said body panel;
a first fastener configured to releasably couple one point of said body panel to another point of said body panel, so as to form an opening to receive at least a portion of the animal therethrough;
a first shoulder panel;
a second shoulder panel joined to said first shoulder panel to form a shoulder section, wherein said shoulder section is resiliently attached to said body panel; and
a second fastener configured to releasably couple an end of said first shoulder panel to and end of said second shoulder panel, so as to form an opening to receive a head of the animal therethrough.

2. The garment of claim 1, wherein said body panel includes a central section, which is configured to be positioned parallel with a spine of the animal, and wherein said first and second pockets are disposed on different sides of said central section.

3. The garment of claim 1, wherein said first shoulder panel and said second shoulder panel each include a pocket.

4. The garment of claim 1, further comprising:
an attachment section included on said outer surface; and
an indica section configured to be selectively attached to said attachment section.

5. The garment of claim 1, wherein said first and second pockets each comprise a plurality of pockets, wherein each said plurality of pockets are directly adjacent to each other.

6. The garment of claim 1, wherein said first and second pockets each comprise a plurality of pockets, wherein each said plurality of pockets are spaced apart from each other.

7. The garment of claim 1, wherein said first and second shoulder panels are resiliently attached to said connection section.

8. The garment of claim 1, further comprising at least one pocket disposed on said inner surface of said body panel, which is configured to be positioned adjacent to the body of the animal when the garment is worn.

9. A garment for an animal comprising:
a body panel configured to be carried upon at least a portion of the animal;
a first pocket and a second pocket carried on said body panel;
a first fastener configured to releasably couple one point of said body panel to another point of said body panel, so as to form an opening to receive at least a portion of the animal therethrough;
a first shoulder panel resiliently attached to said body panel;
a second shoulder panel resiliently joined to said body panel; and
a second fastener configured to releasably couple an end of said first shoulder panel to and end of said second shoulder panel, so as to form an opening to receive a head of the animal therethrough.

10. The garment of claim 9, wherein said body panel includes a central section, which is configured to be positioned parallel with a spine of the animal, and wherein said first and second pockets are disposed on different sides of said central section.

11. The garment of claim 9, wherein said first shoulder panel and said second shoulder panel each include a pocket.

12. The garment of claim 9, wherein each of said pockets have openings that are axially aligned with each other.

13. The garment of claim 9, wherein said first and second pockets each comprise a plurality of pockets, wherein each said plurality of pockets are directly adjacent to each other.

14. The garment of claim 9, wherein said first and second pockets each comprise a plurality of pockets, wherein each said plurality of pockets are spaced apart from each other.

15. The garment of claim 9, wherein said first and second shoulder panels are spaced apart.

16. The garment of claim 9, further comprising at least one pocket disposed on said inner surface of said body panel, which is configured to be positioned adjacent to the body of the animal when the garment is worn.

17. A garment for an animal comprising:
a body panel configured to be carried upon at least a portion of the animal, said body panel having an outer surface and an inner surface, said inner surface adapted to be positioned proximate to the animal when the garment is worn;
a first pocket and a second pocket carried on said outer surface of said body panel;
a first fastener configured to releasably couple one point of said body panel to another point of said body panel, so as to form an opening to receive at least a portion of the animal therethrough;
a first shoulder panel;
a second shoulder panel joined to said first shoulder panel by a base section to form a shoulder section, wherein said first and second shoulder panels are resiliently attached to said base section; and
a second fastener configured to releasably couple an end of said first shoulder panel to and end of said second shoulder panel, so as to form an opening to receive a head of the animal therethrough.

18. The garment of claim 17, wherein said base section is resiliently attached to said body panel.

19. The garment of claim 17, wherein said first shoulder panel and said second shoulder panel each include a pocket.

20. The garment of claim 17, further comprising at least one pocket disposed on said inner surface of said body panel, which is configured to be positioned adjacent to the body of the animal when the garment is worn.
